(19) United States
(12) Patent Application Publication
(10) Pub. No.: US 2004/0160722 A1
(43) Pub. Date: Aug. 19, 2004

(54) Power grid

(76) Inventor: Donald J. E. Miller JR., Tampa, FL (US)

Correspondence Address: Donald J. E. Miller, Jr., 6509 Secrest Ct, Tampa, FL, 33625, US

(21) Appl. No.: 10/369,395

(22) Filed: Feb. 19, 2003

(51) Int. Cl. H02H 9/06

(52) U.S. Cl. 361/118

(57) ABSTRACT

Power Grid is an ac adapter system that plugs into a wall socket. With a rocker switch that turns off and on the ac plugs on the grids power strip, and the power grid also has a serge protector or circuit breaker on the system.

### FIELD OF THE INVENTION

The power grid relates to power strips which plug into the wall socket and having extra outlets, and have a surge protector or a circuit breaker.

### BACKGROUND OF THE INVENTION

An electrical strip with an extension cord that plugs into a wall socket, plus multiple outlets located down the length of the strip and a surge protector or circuit breaker for safety.

### SUMMARY OF THE INVENTION

The power grid is an ac adapter that plugs into an ac outlet. The power grids plug has a rocker switch to turn the power grid off and on, so if the power grid is plugged in behind a desk or dresser it can still be turn off and on from its plug. There is a power light and either a surge protector or a circuit breaker located in the plug of the power grid.

### DESCRIPTION OF DRAWINGS

Page 1. Shows the completed Power Grid and the back view of its plug.

Page 2. Shows the back cover and the inside back, plus the front and the positive, negative and grounder prongs of the power grid plug.

Page 3. Shows the back of the power grid with a circuit breaker or surge protector installed. Also the back inside and front of the power grid is shown with the rocker switch and power light installed.

Page 4. Shows the front of the power grid strip, and the ac socket, rocker switch and power light.

Page 5. Shows the back cover, inside back and the front of the power grid strip with the ac sockets installed.

Page 6. Shows the connected parts and wiring for the back cover and the back inside of the plug and strip of the power grid.

It is to be understood that the present invention is not limited to the details of construction and arrangement of parts illustrated in the accompanying drawings, since the invention is capable of other embodiments, and is capable of being practiced or carried out in various ways within the scope of the claims. Also, it is to be understood, that the phraseology and terminology employed herein is for the purpose of description, and not of limitation.

### DESCRIPTION OF INVENTION

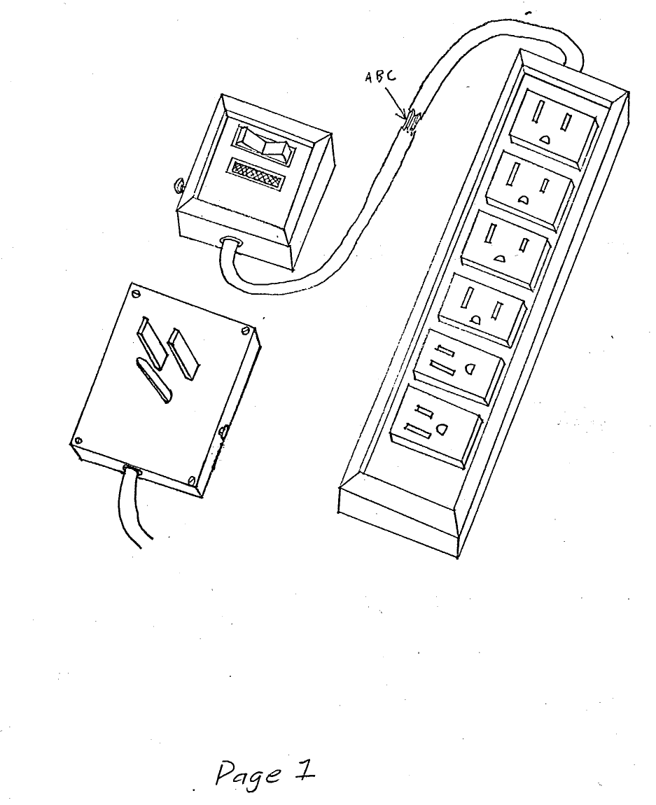

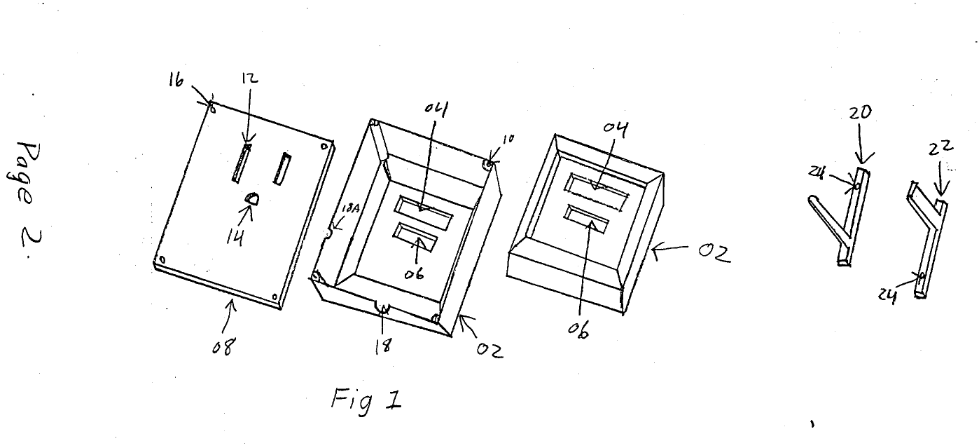

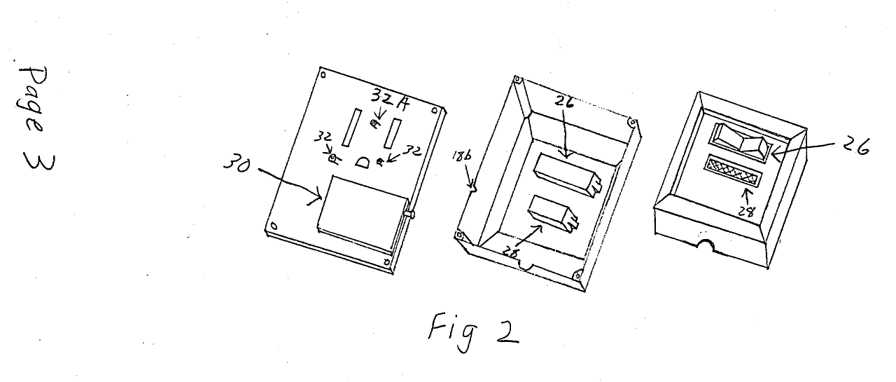

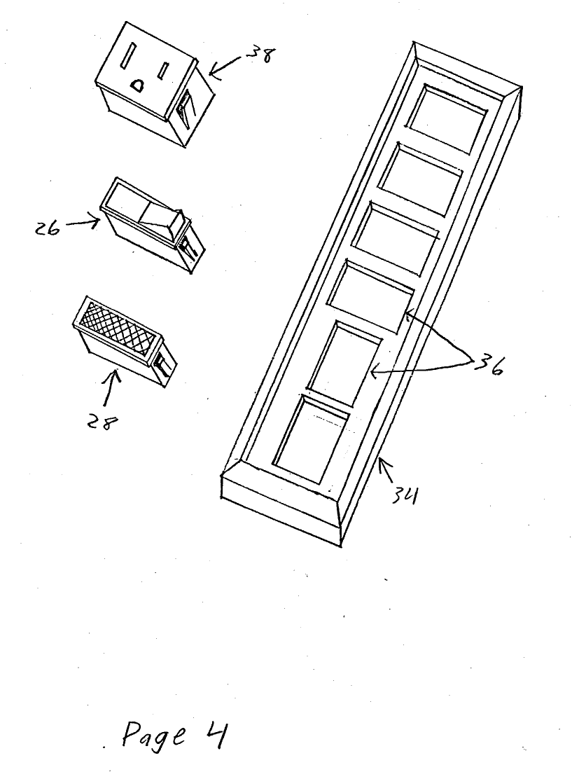

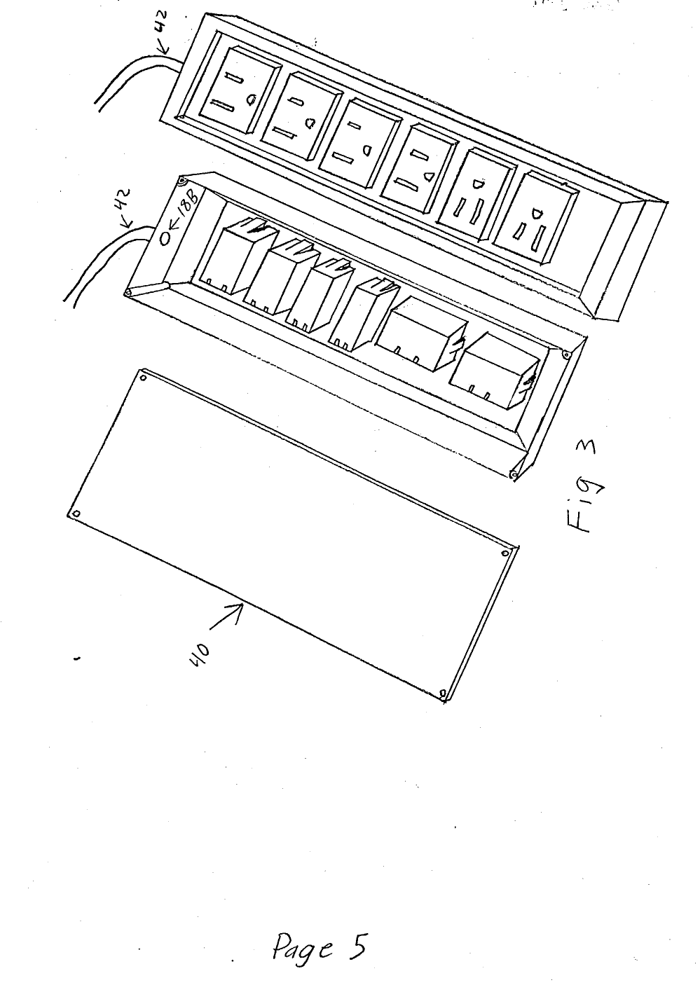

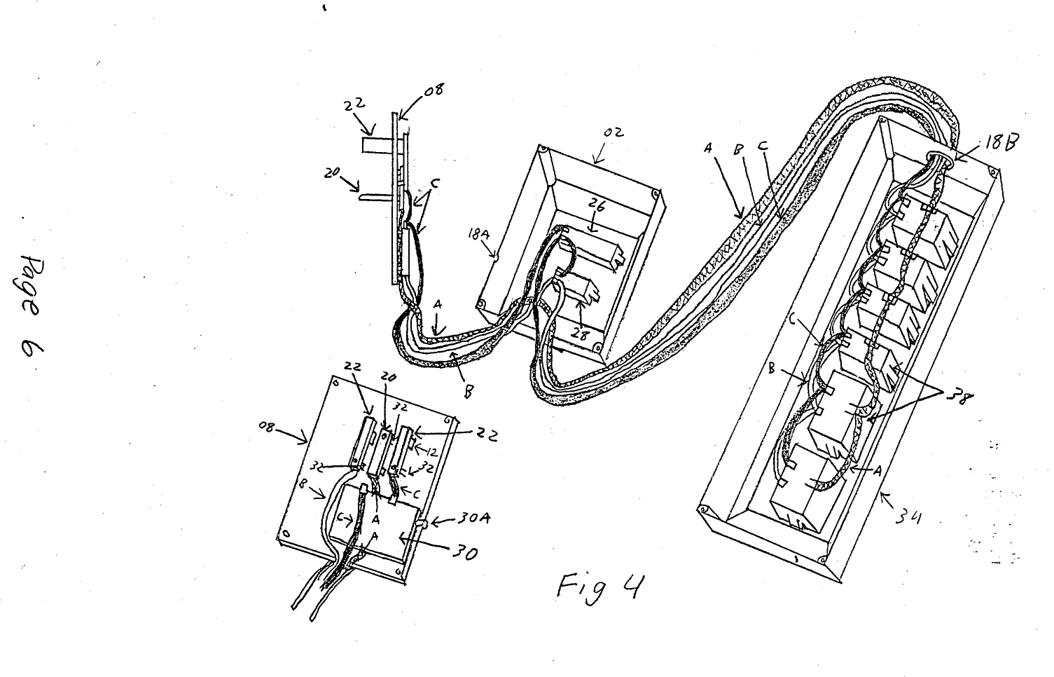

FIG. 4 shows a perspective of the Power Grid, it's an ac adapter that has a off and on rocker switch located on the plug of the power grid. A circuit breaker or surge protector will protect the grid.

Page 1, showing the completed Power Grid. The strip 34 is a rectangle block made of plastic, with the sides being strait and the topsides slanting at a 20-degree angel with the top center of the strip being sunken in, and on the top of the strip are square ac outlet holes 36. The plug of the power grid 02 is basically the same as the strip body except the plug is square shaped and has a rocker switch and power light holes cut into it 04,06, with a hole for the cord 18 and a side hole 18a+for the breaker or protector reset button 30a.

The back cover of the power grids ac plug is a piece of thin square plastic 08. And on the back are three plastic screw tubes 32, 32a one is located between the positive and negative slots 12, and two are located on either side of the grounder hole 14. Near the bottom of the cover is a circuit breaker or surge protector 30. FIG. 4. taking the positive and negative prongs 22 and put the front tip of the prongs through the pos and neg slots 12 and screw them to the plastic tubes 32 located on the side of the grounder hole 14, repeat the same proceedger with the grounder prong 20, inserting the front tip through the grounder hole 14 and screw it to the plastic tube 32a located between the pos and neg slots 12. Then place the rocker switch 26 into its housing on the grids ac plug 04, and continue by placing the power light 28 in its housing located under the rocker switch on the plug 06. Now take the grid strip 34 and put the ac sockets 38 in the housing on the strip 36.

Finish the power grid by connecting the negative wire C to the negative prong 22 then connect the other end to circuit breaker or surge protector 30, now connect the grounder wire A to the grounder prong 20 and the positive wire B connect to the positive prong 22. Take the negative wire C that's connected to the breaker or protector and connect the other end to the positive side of the rocker switch 26 on the plug and cut the wire, and using the same positive wire B connect it to the negative side of the rocker switch 26 and then take the negative wire B and connect it to the negative side of the power light 28 and a small negative wire is attached to the negative side of the rocker switch 26 and the other end is attached to the positive side of the power light 28, the ground wire doesn't connect to anything in the plug.

Take the positive wire B, negative wire C and the grounder wire A and run them through the hole at the bottom of the plug 18. Then take these wires and run them through the grid strips top hole 18B, and connect the positive wire B to the positive side of each ac socket 38, and connect the negative wire C to each of the ac sockets 38 negative sides. The grounder wire A will then be connected to each of the ac sockets grounder pads. Screw the plugs back cover 08 on, and then screw the strips back cover 40 on and it's done.

01. A ac adapter system that allows the ac strip on the system to be turned off or on by a rocker switch on the systems plug.

02. A ac adapter system according to claim 1, wherein said the ac plug having a sunken center and a rocker switch, power light and circuit breaker or surge protector.

03. A ac adapter system according to claim 1, wherein said having an electrical strip with multiple plugs, and sunken center.
